(19) United States
(12) Patent Application Publication
(10) Pub. No.: US 2012/0227319 A1
(43) Pub. Date: Sep. 13, 2012

(54) Modular Green Roof System

(76) Inventor: Lee Jaslow, Baltimore, MD (US)

(21) Appl. No.: 13/043,828

(22) Filed: Mar. 9, 2011

(51) Int. Cl. A01G 9/02

(52) U.S. Cl. 47/65.9

(57) ABSTRACT

An improved modular green roof system for installation on a roof includes: (a) trays, each having a surface chosen from the group of sidewall, bottom and a combination of such surfaces, and having drainage openings that limit the movement of planting media through the surface while promoting maximum root growth and water and moisture transport through the surface, (b) a water management passage, (c) a structural member that extends across each of the trays and attaches to the opposing bottom sidewall to provide rigidity to each tray, (d) locking members for use with the trays, and wherein each of the trays have a locking opening configured to accommodate one of the locking members, (e) stacking members for use with the trays, and wherein each of the trays have a stacking opening configured to accommodate the insertion of one the stacking members, (f) a slope stabilization device, a portion of which is configured to be accommodated in water management passages, and (g) a water retention medium configured for placement below and in direct contact with the tray's bottom surface.

### BACKGROUND OF THE INVENTION

1. Field of the Invention

The present invention relates generally to plant husbandry and to receptacles for growing media. More particularly, the present invention relates to improved, modular, planting systems for roof applications.

2. Description of the Related Art

A “green roof” is a building roof covered with vegetation. “Green roofs” have many attributes that make them preferable to the traditional black, one-dimensional roofs which they often replace, these include: (a) water retention characteristics that dramatically reduce and delay rainwater runoff, (b) heat-absorption characteristics that result in low ambient surface temperatures, largely eliminating summer heat gain to the building below as well as heat radiation to the local environment (known as the urban “heat island” effect), (c) thermal insulation properties that significantly reduce winter heat loss from the building below, and (d) aesthetic and biodiversity characteristics resulting from the creation of natural meadows.

The modern green roof, as developed in northern Europe at the end of the 20th Century, consists of a series of waterproofing, protection, water retention, drainage, growing media, and vegetation layers that extend across the roof surface. With the use of modern geotextiles, plastics, and engineered lightweight media, system weights of less than twenty-five pounds per square foot are possible, making these roofs practical for both new and existing structures.

Green roofs are often referred to as being of either the “continuous” or “modular” type. “Continuous” green roof systems have been proven to provide reliable long-term performance when designed and installed by skilled practitioners. Since its vegetation layer has no boundaries, individual plant species and varieties spread or retreat in response to climatic conditions while maintaining full surface coverage. The growing media, water retention, and drainage layers also have no boundaries, so moisture levels change gradually across the roof and planting media (i.e., the media or medium that supports plant growth in the tray) thickness can vary, whether by intention or not. These factors yield natural-looking meadows with seamless transitions between different plant populations.

“Modular” green roof systems, which utilize portable trays that function as independent growing containers, have more recently been promoted as a way to make green roof design and construction more widely accessible. These trays are typically delivered to the site as fully grown units that are simply laid in place on the roof. The challenge for modular systems has been to achieve the aesthetics, performance, and economics of continuous systems without losing the key modular system features of simplicity and portability.

Examples of patents and patent publications that disclose the technology of modular green roof systems include U.S. Pat. Nos. 4,926,586, 6,178,690, 6,606,823, 6,711,851, 6,862,842, 7,603,808 and 7,716,873 and United States Patent Publication Numbers (USPPN) 2005/0120656, 2007/0094927, and 2009/0320364.

Some of today's simplest modular green roof trays are made with solid, molded plastic sidewalls which have top flanges to provide rigidity for the tray's sidewalls (see U.S. Pat. Nos. 6,862,842 and 6,711,851). A disadvantage of these solid sidewalls is that they prevent the exchange of plant roots and moisture between adjacent trays; meanwhile, the solid sidewalls tend to promote the roots within a tray encircling the tray's interior—which is an undesirable condition for long-term plant health. Additionally, the flanges of such trays, which are not covered with a plant-growth-supporting medium or growing media and are typically black in color for reasons of sunlight stability and economy, absorb solar radiation and become warm, creating a micro-environment that is inhospitable to plant growth. The result is an unsightly grid of barren lines in what would preferably be the sight of continuation vegetation.

Trays having flange-less, non-solid sidewalls have also been used, but they have not been able to overcome the disadvantages mentioned above. For example, see USPPN 2007/0094927 which uses sidewalls having large open areas that are covered by screening/filtering/separation materials or fabrics to retain the contents of the trays in place—however, such fabrics are known to be prone to long-term clogging from fine particles in planting media. See also USPPN 2009/0320364 which uses a two-part sidewall where the top part of the sidewall is either removable after the tray's installation or is biodegradable—however, the remaining part of this sidewall remains solid and therefore still suffers to a degree from the disadvantages previously mentioned for solid sidewall trays, and removal of top part of the trays defeats certain advantages of modular systems relating to roof-leak repair and future portability.

The bottoms of today's modular green roof trays are often configured to aid in irrigating and draining the trays (i.e., provide water retention and drainage). For example, they may have waffled or dimpled bottoms whose lower portions store and retain excess water collected during periods of wet weather for use as supplemental irrigation in dry weather; while perforations in the bottom's upper portions permit excess water to drain from a tray; e.g., see U.S. Pat. Nos. 6,606,823, 6,711,851, and 7,716,873. Other tray bottoms provide drainage without water retention, using the same waffled or dimpled bottoms but with a few small slots at the base of the tray; see USPPN 2009/0320364. With either approach, water can only move outward from the trays, making it difficult to achieve moisture equalization between adjacent trays which would require both inward and outward water movement. Additionally, the solid bottoms of trays make it difficult to provide supplemental irrigation to such trays.

Lack of care during installation of today's modular green roof trays can result in gaps between adjacent trays. Additionally, without sidewall flanges for stiffening, trays tend to bow outward from the internal pressure of planting media, making a tight fit difficult. Connecting sidewalls with conventional mechanical fasteners in an attempt to eliminate these problems can be difficult and time consuming. Some systems attempt to eliminate gaps by overlapping or interlocking sidewalls (see USPPN 2009/0320364 and USPPN 2007/0157514), but these require accurate fitting which is difficult when plants obscure the sidewalls, and overlapping connections make module removal difficult.

Current modular green roof trays are designed for low-slope roofs and do not have sufficient structural strength to resist the compressive loads on slopes. No provision is made in the designs of today's trays for connection to supplemental mechanical-stabilization systems. For these reasons, sloped roof applications require considerable improvisation and custom engineering.

An additional problem encountered in using today's modular green roof trays is their transport, which can be expensive since few provisions are provided in their configurations to assist with stacking them for transport in a manner that will protect their vegetation and media from compression. Often the modules are delivered to the roof on expensive, custom-made, shelf systems.

Thus, while today's modular systems can simplify green roof design and installation, there are many areas in which such systems need improvements—e.g., improvements that provide for better root spread and moisture irrigation between trays, and make it easier for these trays to be irrigated, used on sloped roofs, transported, and reliably installed.

### OBJECTS AND ADVANTAGES

There has been summarized above, rather broadly, the prior art that is related to the present invention in order that the context of the present invention may be better understood and appreciated. In this regard, it is instructive to briefly consider the objects and advantages of the present invention.

It is an object of the present invention to provide a completely new modular green roof system that combines some of the best features of continuous and modular systems.

It is also an object of the present invention to provide an improved modular green roof system that facilitates root spread and moisture equalization between trays, giving the roofs on which they are installed a more continuous and natural appearance.

It is a further object of the present invention to provide an improved modular green roof system with an effective method for supplying and distributing water throughout the system's trays.

It is a still further object of the present invention to reconfigure and modify the trays of modular green roof systems so that these trays are easier to stack and transport.

It is another object of the present invention to provide an improved modular green roof system that overcomes the installation problems of prior modular systems created by bowing sidewalls and difficulties with connecting rows of adjacent trays.

It is yet another object of the present invention to provide an improved modular green roof system that overcomes the installation problems of prior modular systems on sloped roofs due to the structural weakness of the modules and the lack of a means to simply connect the trays to supplemental mechanical stabilization systems.

These and other objects and advantages of the present invention will become readily apparent as the invention is better understood by reference to the accompanying summary, drawings and the detailed description that follows.

### SUMMARY OF THE INVENTION

Recognizing the need for the development of improved modular green roof systems, the present invention is generally directed to satisfying the needs set forth above and overcoming the problems and disadvantages exhibited by prior modular green roof systems.

In accordance with a preferred embodiment of the present invention, an improved modular green roof system, of the kind that utilizes manufactured trays that are designed to be portable and for adjacent installation on a roof and with each of these trays: (i) having a bottom and sidewall surfaces, (ii) having openings for water drainage, (iii) for use with a plant-growth-supporting media, and (iv) planted with vegetation before shipping or planted on a roof after installation, includes: surfaces chosen from the group including the bottom and sidewall surfaces having a plurality of slots or perforations with opening sizes chosen so as to limit the movement of the planting media through said surfaces while allowing for maximum root growth, water drainage, and moisture equalization through said surfaces.

This preferred embodiment of the present invention, may also further include: (a) high-rate water drainage and/or irrigation channels, created by tray fabrications chosen from the group including recessing the lower areas of a tray's sidewalls or providing channels or grooves in a tray's bottom; (b) a geotextile mat under the tray to provide protection, water storage, or capillary water transfer; (c) internal structural members that extend from one sidewall, across the tray, and attach to the tray's opposing sidewall to provide structural rigidity; (d) openings in the tray edges to accommodate locking members or clips that are used to lock together the corners of adjacent, installed trays; (e) openings in the tray to accommodate stacking members that allow the trays to be stacked one on top of the other for transit or storage with a defined spacing height between the stacked trays; (f) irrigation tubing which is configured to fit within the tray's high-rate water drainage and/or irrigation channels; and (g) slope stabilization devices that are configured to fit within the tray's high-rate water drainage and/or irrigation channels.

Thus, there has been summarized above (rather broadly and understanding that there are other preferred embodiments which have not been summarized above) the present invention in order that the detailed description that follows may be better understood and appreciated.

### BRIEF DESCRIPTION OF THE DRAWINGS

FIG. 1 is a perspective view of a preferred embodiment of the present invention.

FIG. 2 is a top view of the embodiment shown in FIG. 1.

FIG. 3 is a side-sectional view of the embodiment shown in FIG. 1.

FIG. 4 is an enlarged perspective view of the side slots and ribs of the embodiment shown in FIG. 1.

FIG. 5 is a top view of the side slots and ribs of two adjacent trays of the present invention which shows how the inter-tray passages remain open regardless of the tray alignment.

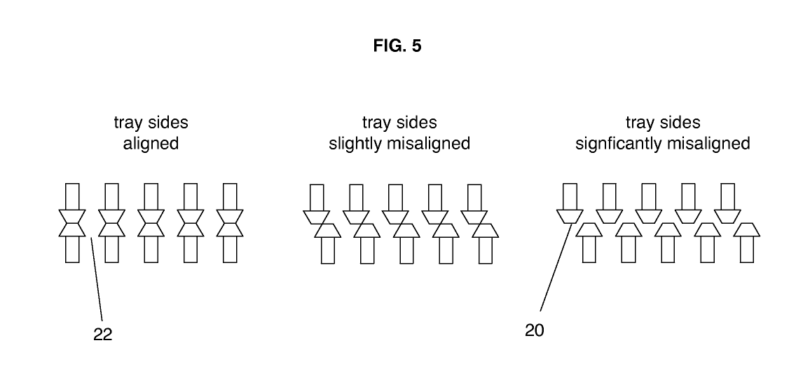

FIG. 6 is a side view of the three adjacent trays of the present invention which shows internal drainage channels or water management passages created by the intersection of the bottom portions of adjacent trays.

FIG. 7 is a side view of an alternate embodiment with a central water management passage and vertical sidewalls.

FIG. 8 is a side-sectional view of the trays, water-retaining geotextile mat and irrigation system of a preferred embodiment of the present invention where the tray has been filled with a lightweight, plant-growth-supporting medium and planted with vegetation, which in this instance is a pre-grown vegetated mat.

FIG. 9 is a perspective view of four similarly configured trays of the present invention sitting adjacent each other and connected with either the 2-prong or 4-prong clips which are shown above each tray corner.

FIG. 10 is an enlargement of one of the tray center intersections shown in FIG. 9.

FIG. 11 is an enlargement of one of the tray edge intersections shown in FIG. 9.

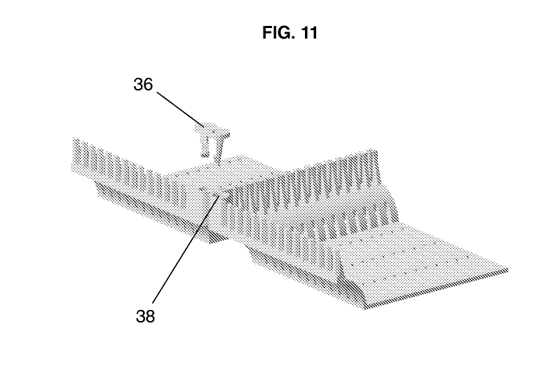

FIG. 12 is an exploded perspective view which shows the process of stacking three trays on top of the other for shipping using two types of stacking spacers.

FIG. 13 is a perspective view which shows the stacked trays of FIG. 12.

FIG. 14 is a perspective view of four similarly configured trays of the present invention which shows one method for slope stabilization.

FIG. 15 is a side view of the slope stabilization method shown in FIG. 14 showing the internal structural support rib.

FIG. 16 is an enlargement of one of the central intersections of the slope stabilization method shown in FIG. 14 showing the fastening system.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

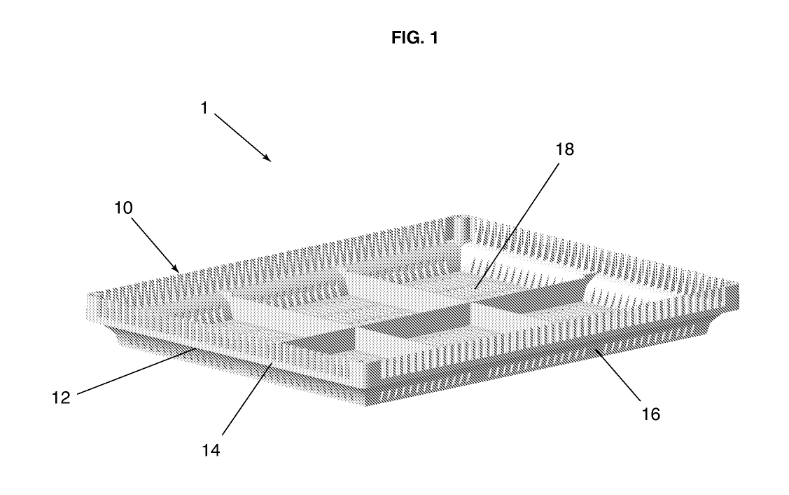

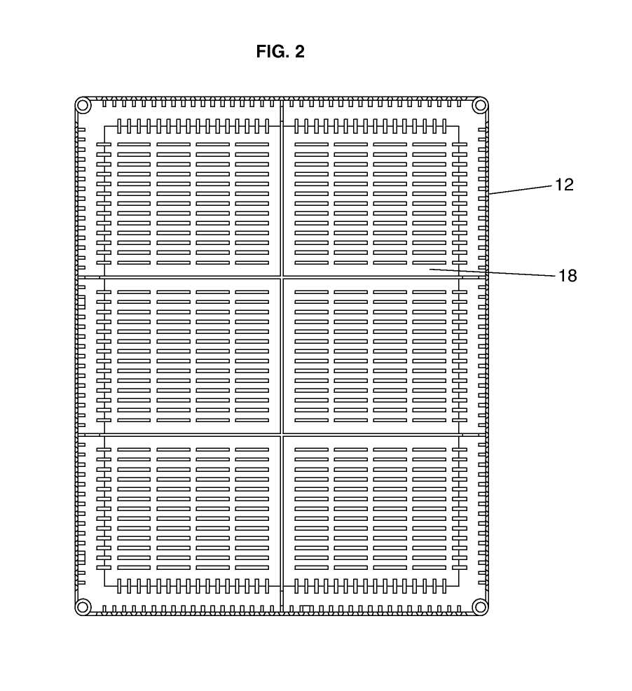

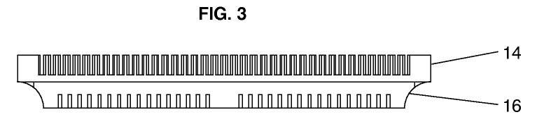

FIG. 1 shows a perspective view of the preferred embodiment of the present invention 1. This preferred embodiment consists of an injection-molded, plastic, rectangular tray 10 for use in modular green roof applications. The tray has four sidewall surfaces 12 and a bottom surface 18, all surfaces having a plurality of slots or perforations. Each of the sidewall surfaces consists of an upper portion 14 and a lower portion 16. See FIG. 2 for a top view of this tray and FIG. 3 for a side view of this tray.

As such, the present invention discloses a completely new design solution for the sidewalls of the trays that are used in modular green roof systems 1. This tray's new configuration does away the prior trays' problematic, solid sidewalls and their reinforcing flanges without the need for utilizing removable inserts (e.g., see USPPN 2009/0320364) or problematic separation fabrics (e.g., see USPPN 2007/0094927).

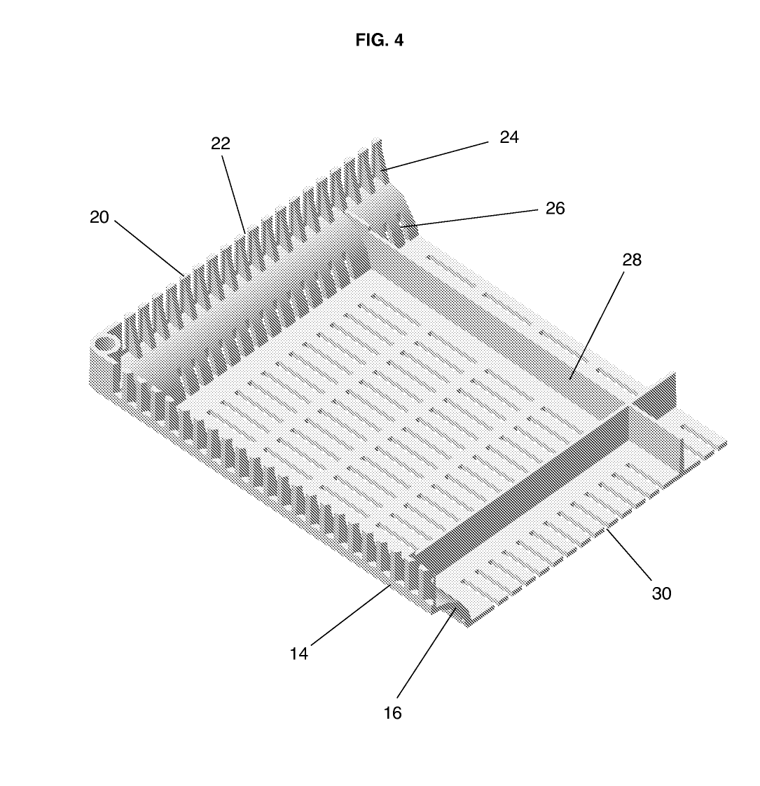

The present invention solves these problematic aspects of prior trays by incorporating sidewalls whose top portions 14 are made by utilizing thin, reinforced, vertical members 20 separated by a specified spacing or gaps or drainage openings 22 sufficiently small to retain the lateral spread of a tray's planting media (i.e., the medium that supports plant growth in the tray) while promoting lateral root growth, water drainage, and moisture equalization through these sidewall surfaces (i.e., openings chosen with characteristic dimensions that limit the movement of the planting media through the surface while promoting maximum root growth and water and moisture transport through the surface). See FIG. 4. The reinforcement for these members is provided by ribs 24 which project perpendicularly from the back of the members and are anchored to the inner side of the sidewall's bottom portion 16. These ribs also help to discourage possible root encirclement around the sidewalls of a tray, encouraging roots to grow through the slots and into the adjacent trays.

In a preferred configuration, the cross-sectional shapes of these members 20 are selected such that the spacing between them is trapezoidal so as minimize the chances of blocking the passageways between the members of adjacent trays, even when the trays are misaligned. For lightweight, engineered green roof media, rib gap widths in the range of 1/16 to ¼ of an inch have been found to perform satisfactorily for this purpose. Since the rib widths are typically chosen to lie within the range of ⅛ to ½ inch, it often times happens that the open area of the sidewall's top portion can approach one-third of the total surface area. The thickness and height of these ribs are then selected to provide the desired depth of growing media while ensuring that there are no adverse impacts on structural strength.

Having trays with sufficiently strong sidewalls proves to be quite an advantage for the present invention since its trays, when situated in an adjoining manner on a roof, do not need to have their sidewalls configured so that they can be interlocked—which we previously noted can be quite problematic (e.g., problems with aligning, fitting and connecting/installing such trays). Additionally, a tray's opposing sidewalls and bottom are reinforced with structural members or stiffeners 26 that extend across a tray's bottom surface to prevent the trays from bending during shipping and handling or from the lateral forces imposed on the trays when they are situated on sloped roofs (i.e., configured to provide rigidity to the tray). These stiffeners also help to prevent the erosion on a tray's planting media when the trays are situated on sloped roofs.

The bottom or lower portions 16 of the tray's sidewalls have slots 28 whose widths or characteristic dimensions are again chosen so as to limit the vertical movement of the planting media within the trays while allowing maximum lateral water drainage and moisture transfer. For lightweight, engineered green roof media, slot widths in the range of 1/16 to ¼ of an inch have been found to perform satisfactorily for this purpose. Since the slot spacing is typically chosen to lie within the range of ⅛ to ½ inch, it often times happens that the open area of the lower portions of the tray's sidewalls can approach one-third of the total surface area. The size and spacing of these slots are then selected to ensure that there is no adverse impact on structural strength.

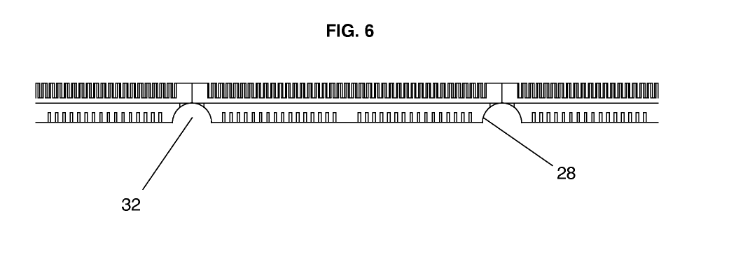

The sidewalls of the preferred embodiment shown in FIG. 1 also differ from those of most prior trays in that the bottom portions 16 of this embodiment's sidewalls are generally recessed with respect to their corresponding top portions 14 so that the sidewall recessed portions of adjacent, installed trays form one of a plurality of semi-circular water management passages 32 among installed trays, facilitating drainage and irrigation. See FIG. 6. Meanwhile, the sidewall's lower portion slots 28 provide a direct drainage pathway from the growing media inside the trays to these water management passages.

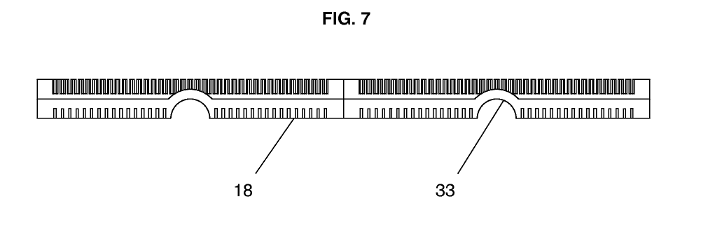

Because the present invention's water management passages 32 have proved themselves to be so useful to the operational effectiveness of this system, it should be noted that their location within a tray need not be limited to being only on/within a tray's sidewalls or between adjoining trays. For example, the bottom surface 18 of a tray can be configured so that it has channels or grooves that serve as a system's water management passages. See FIG. 7 for a side view of a tray having a semi-circular water management passage 33 located in the bottom of a tray. It can also be noted that the sidewalls of such trays need not be of the two-part or two-portion type (i.e., top or upper 14 and bottom or lower 16 portions). Instead, the sidewalls of trays with central water management passages may be vertical and completely configured with slots, openings or perforations whose sizes or characteristic dimensions are chosen so as to limit the lateral movement of the planting media within the trays while allowing for maximum lateral root growth, water drainage, and moisture equalization between adjoining trays.

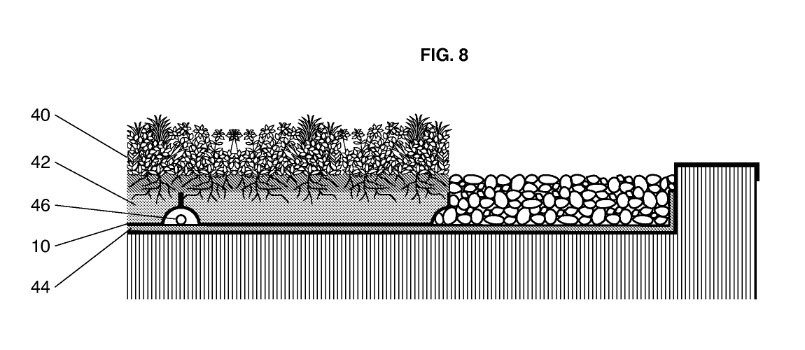

Like prior trays, the bottom surface of the present invention has drainage openings or perforations 30. See FIG. 4. However, the present invention differs dramatically in the number and size of its openings and the resulting porosity (i.e., void fraction) of its bottom surface. The sizes or characteristic dimensions of said drainage openings are chosen so as to limit the lateral movement of the planting media within the trays while allowing for maximum vertical root growth, water drainage, and moisture transfer between the tray's vegetation 40 (in this instance a pre-grown vegetated mat applied over the filled tray), planting media 42, through the tray 10 and into underlying water-retention media and materials such as water-retaining geotextile mats 44. Such materials are well known by those of ordinary skill in the art and will therefore not be described in further detail herein. See FIG. 8. For lightweight, engineered green roof media, slot widths in the range of 1/16 to ¼ of an inch have been found to perform satisfactorily for this purpose. Since the slot spacing is typically chosen to lie within the range of ⅛ to ½ inch, it often times happens that the open area of the tray bottoms can approach one-third of the total surface area. Such large open areas, while providing for sufficient structural integrity of the tray's bottom surface, are needed to allow for the present invention's novel and improved water management methods that maximize the transfer of water and moisture out of, in to, and between adjacent trays.

While the tray generally described above is shown as having specialized drainage openings in both its sidewall and bottom surfaces, it should be recognized that there are other tray configurations that can be useful in certain situations while not utilizing these specialized openings in both the sidewall and bottom surfaces. For example, trays having such specialized drainage openings in only the sidewall or only in the bottom surfaces are considered to fall within the scope of the present invention.

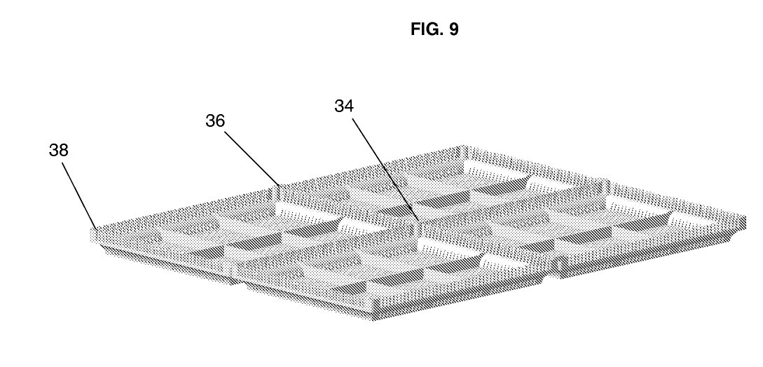

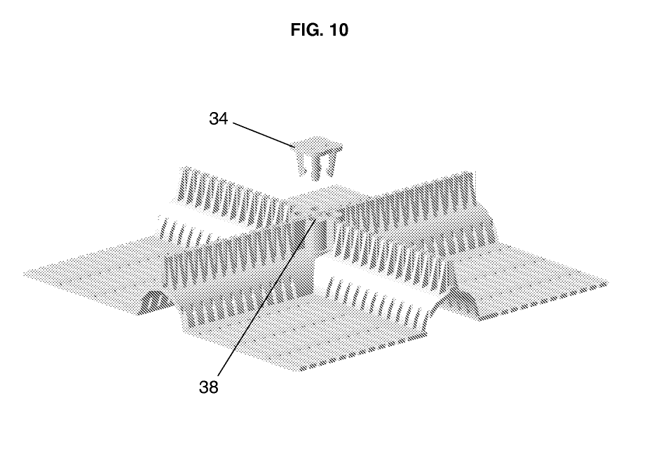

Installed, adjacent trays are securely connected with plastic prongs, clips or locking members, either of the 4-prong 34 at interior intersections or of the 2-prong 36 at exterior intersections, that are easily inserted into locking openings 38 provided at the tray's corners and are configured such that they lock in place without the need to use tools. These openings 38 have a substantial diameter and are open at their bottoms to prevent clogging should growth media or plant matter fall into them. Alternatively, other specialized locking openings 38 can be configured elsewhere in the tray's sidewalls to accommodate these locking members. The clips 34 and 36 are configured to easily insert and lock in place even when the trays do not precisely align at their corners; thus, allowing for significant variations in installed tray alignments and the easy insertion of removal of the clips—thereby making it easier to install the trays of the present invention. See FIGS. 9-10.

The present invention discloses a completely novel method of managing water transport between installed trays. When it rains, water can drain freely out of the present invention's trays through the slots or perforations in their high porosity sidewalls and bottoms. Some of this rainwater is collected and stored in the present invention's novel placement of a water retention medium such as a geotextile mat 44 underneath the trays' bottoms and extending such that this mat also passes beneath the high-rate, water drainage and irrigation passages 32 that are created between the installed trays. Such geotextile mats can also serve to help protection an underlying roof structure.

This geotextile mat 44 is chosen and configured so that it can retain a similar or larger quantity of water than that of the prior art's waffled bottomed trays. However, the novel placement of this mat has the advantage that excess water is retained beneath the trays where there is no risk of the plant media within the trays becoming saturated. Additionally, for modular green roof applications on flat roofed buildings, a mat with capillary properties can be employed to wick water horizontally and vertically, assure uniform water distribution across all trays and prevent the accumulation of excess water in a flat roof's low areas. When the media planted in the installed trays begins to dry out, the water retained in the mat moves upward into the trays through the highly porous tray bottoms to help supply the moisture needed by the media. During extended periods of hot, dry weather, the mat can be wetted by the lines or tubing of a drip irrigation system 46 placed within the semi-circular passages 32 between the adjacent trays. The drip irrigation system of the present invention, because of its unique placement and use with-a specially configured water-retaining mat, has been proven to be much more effective and efficient than drip irrigation systems installed under or the sprinkler systems installed over prior art, modular green roof systems. Geotextile-type capillary mats and drip irrigation systems installed under or the sprinkler systems installed over prior art, modular green roof systems. Geotextile-type capillary mats and drip irrigation systems suitable for use with the present invention are well known in the art and therefore will not be discussed in greater detail herein.

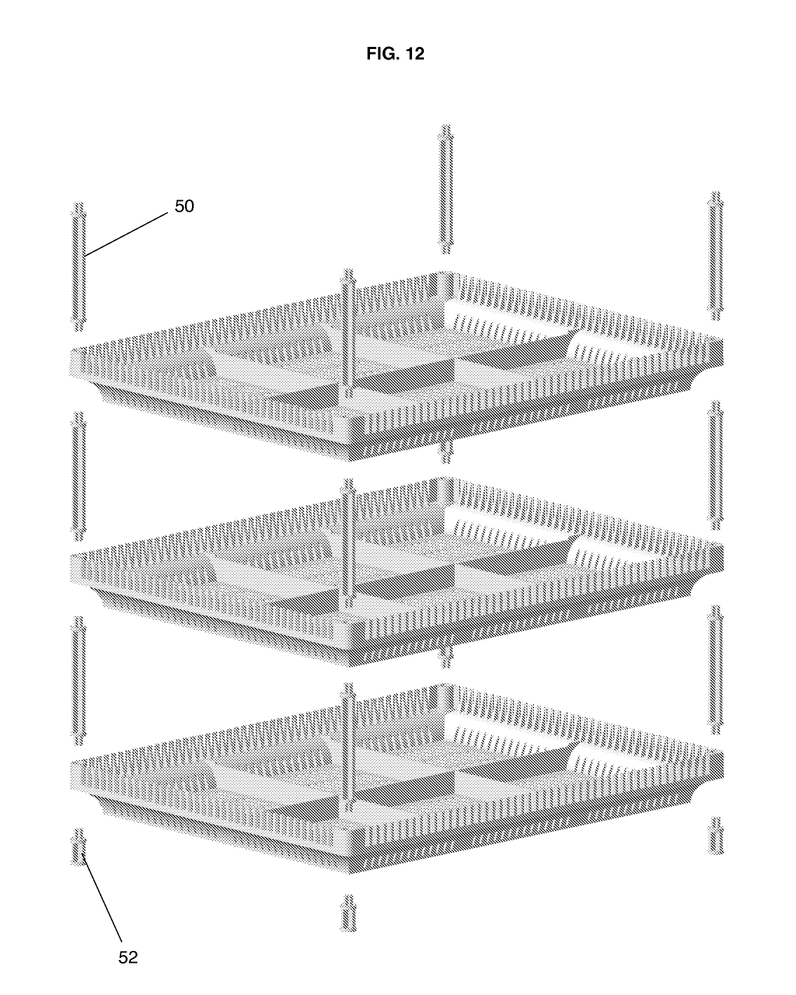

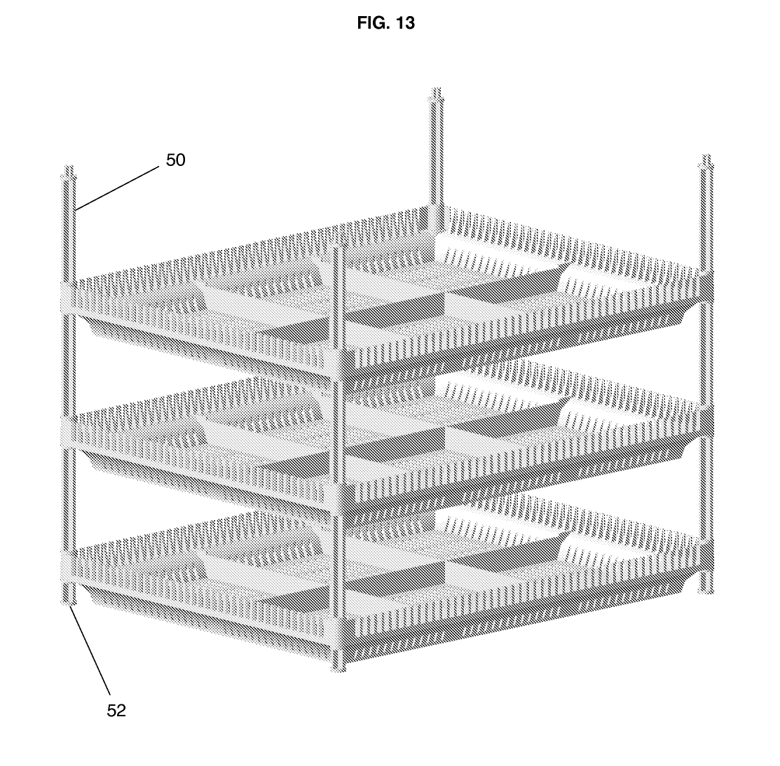

The openings at the tray's corners have also been configured to accommodate stacking members or spacers 50 and 52 which easily allow the present invention's pre-planted trays to be stacked one on the top of the other for shipment and storage (i.e., the locking openings also serve as stacking openings and we just refer to them as openings 38). See FIGS. 12 and 13. Alternatively, other specialized spacer or stacking openings can be configured elsewhere in the tray to accommodate these spacers. These spacers eliminate pressure on the pre-planted vegetation and provide them with ventilation which helps assure that they can be safely shipped.

For installation on sloped roofs, the present invention's stacking and connecting openings or water management passages 32 can also be configured to facilitate a variety of slope stabilization devices 60. These devices and such slope stabilization methods serve to transfer sliding forces upward or downward to building structural elements capable of withstanding the substantial weight of wet planting media. For example, an extruded aluminum structural channel 60 sized to fit within the water management passages 32 can extend from the top to the bottom of the modular tray system and bear on a structurally strong bottom curb or parapet at the edge of the roof on which the present invention is being installed.

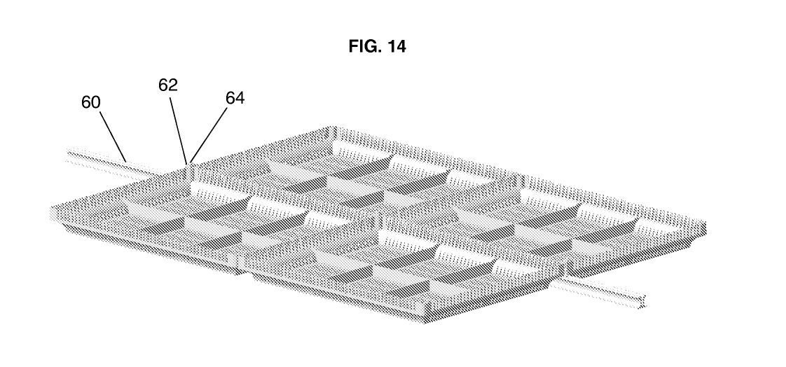

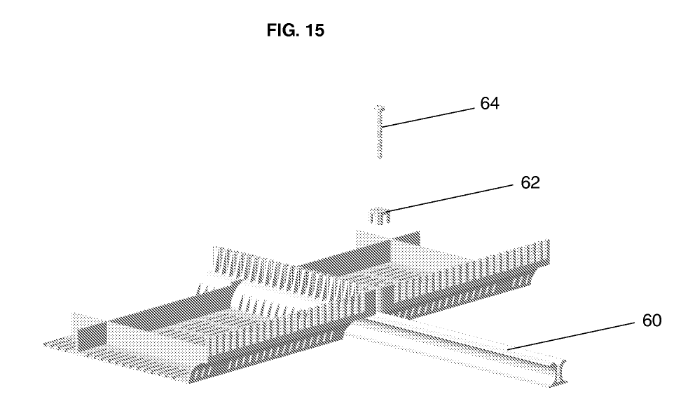

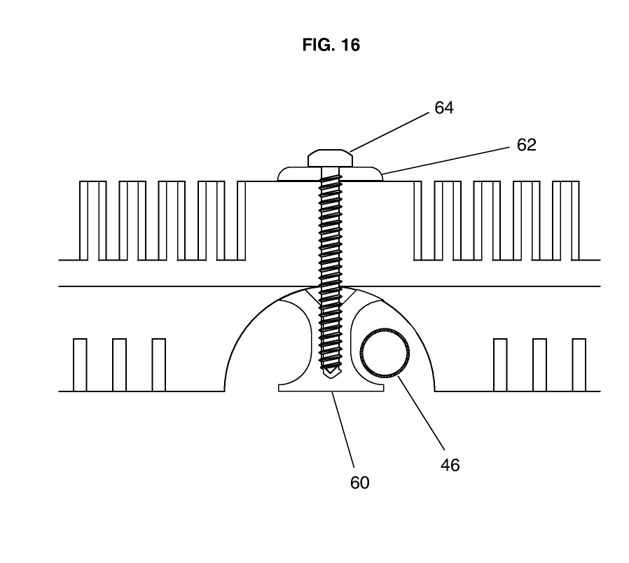

Four-way metal clips 62 that fit into the openings 38 at the tray's corners can be attached with screws 64 into a formed internal profile in the structural channel without the need for drilling. See FIGS. 14-16. If a structural bottom curb is not feasible, the aluminum channel can be held by a top bracket attached to a structural member at the roof peak.

It can also be noted that, in these sloped roof applications, a high coefficient of friction between the geotextile mat's top surface and the underside of a tray's bottom is highly desirable. The slotted nature of the present invention bottom surface proves to be an effective means for achieving such a desired high coefficient of friction.

The foregoing is considered as illustrative only of the principles of the invention. Further, since numerous modifications and changes will readily occur to those skilled in the art, it is not desired to limit the invention to the exact construction and operation shown and described herein, and accordingly, all suitable modifications and equivalents may be resorted to, falling within the scope of the invention that is hereinafter set forth in the claims to the invention.

I claim:

1. An improved modular green roof system of the kind having a plurality of trays configured for adjacent installation on a roof to cover a defined surface area of said roof, and wherein each of said trays being configured so as to be filled with a planting media and suitably chosen vegetation which issues forth roots, and each of said trays having a bottom and sidewall surfaces that include drainage openings for water drainage from said trays, wherein the improvement comprising:
a surface chosen from the group of said sidewall surface, said bottom surface and the combination of said sidewall and bottom surfaces, and said chosen surface having drainage openings with characteristic dimensions chosen so as to limit the movement of said planting media through said surface while promoting maximum root growth and water and moisture transport through said surface.

2. The improved modular green roof system as recited in claim 1, wherein the improvement further comprising:
a water management passage situated at a location chosen from the group consisting of within said tray sidewall surface and in said tray bottom surface.

3. The improved modular green roof system as recited in claim 1, wherein the improvement further comprising:
a structural member that extends across said each of said trays and attaches to the opposing bottom sidewall portion of said trays, said structural member configured to provide rigidity to said tray.

4. The improved modular green roof system as recited in claim 2, wherein the improvement further comprising:
a structural member that extends across said each of said trays and attaches to the opposing bottom sidewall portion of said trays, said structural member configured to provide rigidity to said tray.

5. The improved modular green roof system as recited in claim 1, wherein the improvement further comprising:
a plurality of locking members for use with each of said trays, and
wherein each of said tray having a locking opening configured to accommodate the insertion of one of said locking members into each of said locking openings for locking together said adjacent trays.

6. The improved modular green roof system as recited in claim 2, wherein the improvement further comprising:
a plurality of locking members for use with each of said trays, and
wherein each of said tray having a locking opening configured to accommodate the insertion of one of said locking members into each of said locking openings for locking together said adjacent trays.

7. The improved modular green roof system as recited in claim 3, wherein the improvement further comprising:
a plurality of locking members for use with each of said trays, and
wherein each of said tray having a locking opening configured to accommodate the insertion of one of said locking members into each of said locking openings for locking together said adjacent trays.

8. The improved modular green roof system as recited in claim 4, wherein the improvement further comprising:
a plurality of locking members for use with each of said trays, and
wherein each of said tray having a locking opening configured to accommodate the insertion of one of said locking members into each of said locking openings for locking together said adjacent trays.

9. The improved modular green roof system as recited in claim 1, wherein the improvement further comprising:
a stacking member for use with each of said trays, and
wherein each of said trays having a stacking opening configured to accommodate the insertion of said stacking member into said stacking opening for allowing said trays to be stacked one on top of the other for the purpose of transporting said trays, and with a defined spacing height between said stacked trays.

10. The improved modular green roof system as recited in claim 2, wherein the improvement further comprising:
a stacking member for use with each of said trays, and
wherein each of said trays having a stacking opening configured to accommodate the insertion of said stacking member into said stacking opening for allowing said trays to be stacked one on top of the other for a purpose chosen from the group of consisting of storage and transit, and with a defined spacing height between said stacked trays.

11. The improved modular green roof system as recited in claim 3, wherein the improvement further comprising:
a stacking member for use with each of said trays, and
wherein each of said trays having a stacking opening configured to accommodate the insertion of said stacking member into said stacking opening for allowing said trays to be stacked one on top of the other for a purpose chosen from the group of consisting of storage and transit, and with a defined spacing height between said stacked trays.

12. The improved modular green roof system as recited in claim 4, wherein the improvement further comprising:
a stacking member for use with each of said trays, and
wherein each of said trays having a stacking opening configured to accommodate the insertion of said stacking member into said stacking opening for allowing said trays to be stacked one on top of the other for a purpose chosen from the group of consisting of storage and transit, and with a defined spacing height between said stacked trays.

13. The improved modular green roof system as recited in claim 5, wherein the improvement further comprising:
a stacking member for use with each of said trays,
wherein each of said trays having an opening chosen from the group of said locking opening further configured to accommodate the insertion of said stacking member into said locking opening and a stacking opening configured to accommodate the insertion of said stacking member into said stacking opening, and
wherein said stacking member configured for allowing said trays to be stacked one on top of the other for a purpose chosen from the group consisting of storage and transit, and with a defined spacing height between said stacked trays.

14. The improved modular green roof system as recited in claim 6, wherein the improvement further comprising:
a stacking member for use with each of said trays,
wherein each of said trays having an opening chosen from the group of said locking opening further configured to accommodate the insertion of said stacking member into said locking opening and a stacking opening configured to accommodate the insertion of said stacking member into said stacking opening, and
wherein said stacking member configured for allowing said trays to be stacked one on top of the other for a purpose chosen from the group consisting of storage and transit, and with a defined spacing height between said stacked trays.

15. The improved modular green roof system as recited in claim 7, wherein the improvement further comprising:
a stacking member for use with each of said trays,
wherein each of said trays having an opening chosen from the group of said locking opening further configured to accommodate the insertion of said stacking member into said locking opening and a stacking opening configured to accommodate the insertion of said stacking member into said stacking opening, and
wherein said stacking member configured for allowing said trays to be stacked one on top of the other for a purpose chosen from the group consisting of storage and transit, and with a defined spacing height between said stacked trays.

16. The improved modular green roof system as recited in claim 8, wherein the improvement further comprising:
a stacking member for use with each of said trays,
wherein each of said trays having an opening chosen from the group of said locking opening further configured to accommodate the insertion of said stacking member into said locking opening and a stacking opening configured to accommodate the insertion of said stacking member into said stacking opening, and
wherein said stacking member configured for allowing said trays to be stacked one on top of the other for a purpose chosen from the group consisting of storage and transit, and with a defined spacing height between said stacked trays.

17. The improved modular green roof system as recited in claim 2, wherein the improvement further comprising:
a slope stabilization device, and
wherein water management passage configured to accommodate the placement of a portion of said slope stabilization device in said water management passage.

18. The improved modular green roof system as recited in claim 4, wherein the improvement further comprising:
a slope stabilization device, and
wherein water management passage configured to accommodate the placement of a portion of said slope stabilization device in said water management passage.

19. The improved modular green roof system as recited in claim 6, wherein the improvement further comprising:
is a slope stabilization device, and
wherein water management passage configured to accommodate the placement of a portion of said slope stabilization device in said water management passage.

20. The improved modular green roof system as recited in claim 8, wherein the improvement further comprising:
a slope stabilization device, and
wherein water management passage configured to accommodate the placement of a portion of said slope stabilization device in said water management passage.

21. The improved modular green roof system as recited in claim 10, wherein the improvement further comprising:
a slope stabilization device, and
wherein water management passage configured to accommodate the placement of a portion of said slope stabilization device in said water management passage.

22. The improved modular green roof system as recited in claim 12, wherein the improvement further comprising:
a slope stabilization device, and
wherein water management passage configured to accommodate the placement of a portion of said slope stabilization device in said water management passage.

23. The improved modular green roof system as recited in claim 14, wherein the improvement further comprising:
a slope stabilization device, and
wherein water management passage configured to accommodate the placement of a portion of said slope stabilization device in said water management passage.

24. The improved modular green roof system as recited in claim 15, wherein the improvement further comprising:
is a slope stabilization device, and
wherein water management passage configured to accommodate the placement of a portion of said slope stabilization device in said water management passage.

25. The improved modular green roof system as recited in claim 16, wherein the improvement further comprising:
a slope stabilization device, and
wherein water management passage configured to accommodate the placement of a portion of said slope stabilization device in said water management passage.

26. The improved modular green roof system as in one of claims 1-25, wherein the improvement further comprising:
a water retention medium in a form chosen from the group of a geotextile mat and other water retention media, and wherein said water retention medium is further configured for placement below and in direct contact with said bottom surface of said tray.
